(19) United States
(12) Patent Application Publication
(10) Pub. No.: US 2020/0242332 A1
(43) Pub. Date: Jul. 30, 2020

(54) INTEGRATING SCANNED BUSINESS CARDS WITH IDENTIFICATION OF MEETING ATTENDEES IN A GIVEN SEATING ARRANGEMENT

(71) Applicant: International Business Machines Corporation, Armonk, NY (US)

(72) Inventors: Jonathan Lenchner, Nairobi (KE); Lisa Seacat DeLuca, Baltimore, MD (US); Maharaj Mukherjee, Poughkeepsie, NY (US)

(21) Appl. No.: 16/257,576

(22) Filed: Jan. 25, 2019

(51) Int. Cl. G06K 9/00; G06Q 10/06

(52) U.S. Cl. CPC G06K 9/00228; G06K 9/00892; G06Q 10/06

(57) ABSTRACT

A business card information storing method, system, and computer program product include scanning a business card of an attendees of a meeting, capturing an image of the attendee met at the meeting and associating the image with the scanned business card of the attendee, surveying for a seat location of the attendee by matching the seat location with the captured image of the attendee, and associating the seat location of the attendee, the image of the attendee, and the business card of the attendee together.

### BACKGROUND

The present invention relates generally to a business card information storing method, and more particularly, but not by way of limitation, to a system, method, and computer program product for scanning a set of business cards and associating the scanned information with an attendee of a meeting at a specific location within a meeting room to remind the host who each attendee is and provide a little bit of information about the person.

During a meeting, business associates are often given business cards of the attendees but then have trouble connecting the names/business cards to the faces of the people in the meeting room.

Conventional techniques include business cards with faces on them. However, if some attendees of a business meeting do not have these types of business cards, this technique does not assist an attendee in trying to associate business cards with faces.

### SUMMARY

Thus, the inventors have identified a need in the art for a technique to connect the business cards to the faces of attendees and automatically match the faces to where the attendees are seated in a given meeting. The method also helps the attendees remember the names of the other attendees and something about each of them.

In an exemplary embodiment, the present invention provides a computer-implemented business card information storing method, the method including scanning a business card of an attendee met at a meeting in a meeting room, capturing an image of the attendee met at the meeting and associating the image with the scanned business card of the attendee, surveying the meeting room for a seat location of the attendee by matching an image of the attendee while seated with the captured image of the attendee, and associating the seat location of the attendee, the image of the attendee, and the business card of the attendee together.

One or more other exemplary embodiments include a computer program product and a system, based on the method described above.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a business card information storing method 100 according to an embodiment of the present invention;

FIG. 2 exemplarily depicts one exemplary association of business cards to seating locations in a business meeting;

FIG. 3 depicts a cloud-computing node 10 according to an embodiment of the present invention;

FIG. 4 depicts a cloud-computing environment 50 according to an embodiment of the present invention; and

FIG. 5 depicts abstraction model layers according to an embodiment of the present invention.

### DETAILED DESCRIPTION

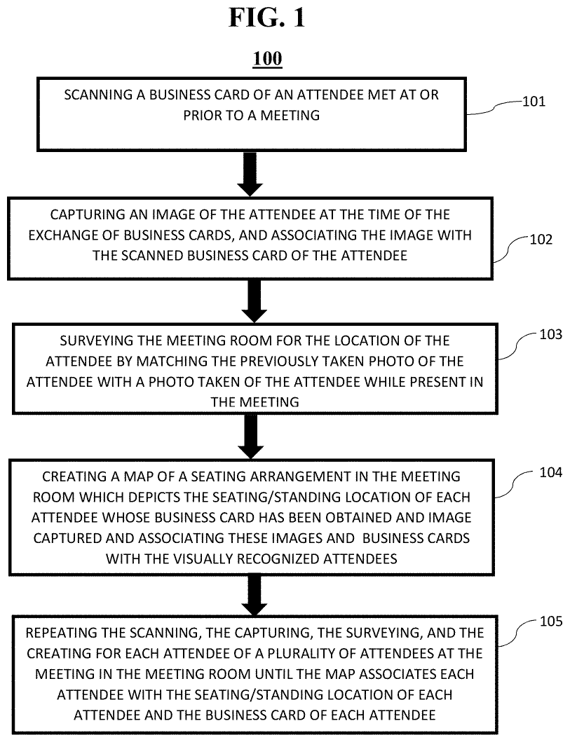

The invention will now be described with reference to FIGS. 1-5, in which like reference numerals refer to like parts throughout. It is emphasized that, according to common practice, the various features of the drawing are not necessarily to scale. On the contrary, the dimensions of the various features can be arbitrarily expanded or reduced for clarity.

By way of introduction of the example depicted in FIG. 1, an embodiment of a business card information storing method 100 according to the present invention can include various steps for helping identify attendees of a meeting and their location within a room to help a specific other meeting attendee remember each attendee while not requiring the attendees to have any special type (i.e., interactive, digital, photographic, etc.) of business card.

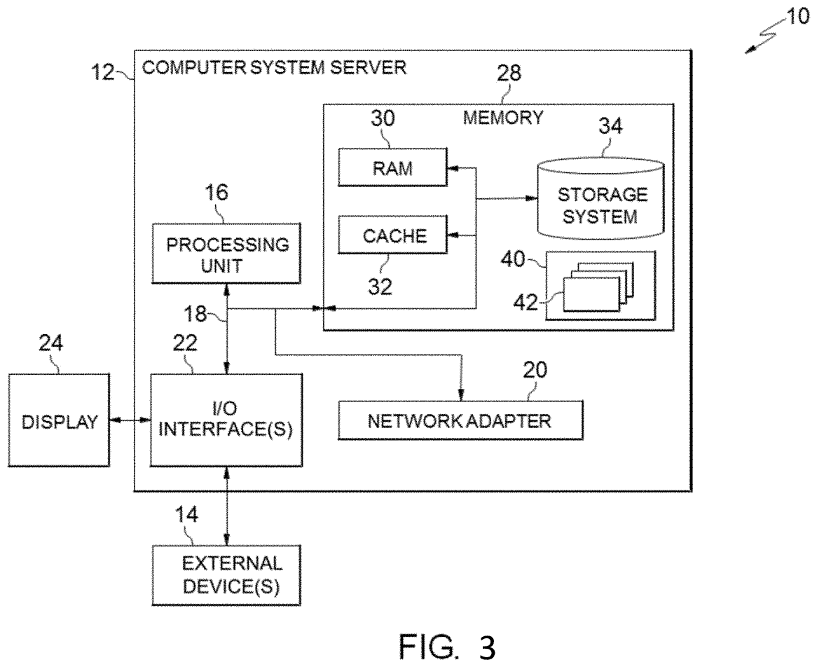

By way of introduction of the example depicted in FIG. 3, one or more computers of a computer system 12 according to an embodiment of the present invention can include a memory 28 having instructions stored in a storage system to perform the steps of FIG. 1.

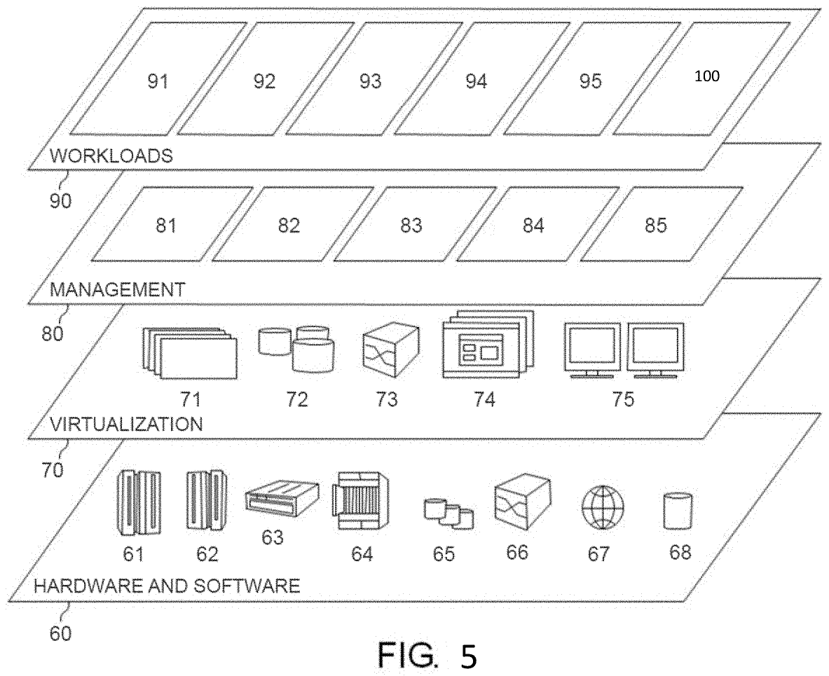

Although one or more embodiments may be implemented in a cloud environment 50 (e.g., FIG. 5), it is nonetheless understood that the present invention can be implemented outside of the cloud environment.

The method 100 may act in a more sophisticated and useful fashion, and in a cognitive manner while giving the impression of mental abilities and processes related to knowledge, attention, memory, judgment and evaluation, reasoning, and advanced computation. That is, a system is said to be “cognitive” if it possesses macro-scale properties—perception, goal-oriented behavior, learning/memory and action—that characterize systems (i.e., humans) that all agree are cognitive.

Cognitive states are defined as functions of measures of a host's total behavior collected over some period of time from at least one personal information collector (e.g., including musculoskeletal gestures, speech gestures, eye movements, internal physiological changes, measured by imaging circuits, microphones, physiological and kinematic sensors in a high dimensional measurement space, etc.) within a lower dimensional feature space. In one exemplary embodiment, certain feature extraction techniques are used for identifying certain cognitive and emotional traits. Specifically, the reduction of a set of behavioral measures over some period of time to a set of feature nodes and vectors, corresponding to the behavioral measures' representations in the lower dimensional feature space, is used to identify the emergence of a certain cognitive state(s) over that period of time. One or more exemplary embodiments use certain feature extraction techniques for identifying certain cognitive states. The relationship of one feature node to other similar nodes through edges in a graph corresponds to the temporal order of transitions from one set of measures and the feature nodes and vectors to another. Some connected subgraphs of the feature nodes are herein also defined as a “cognitive state”. The present application also describes the analysis, categorization, and identification of these cognitive states further feature analysis of subgraphs, including dimensionality reduction of the subgraphs, for example graphical analysis, which extracts topological features and categorizes the resultant subgraph and its associated feature nodes and edges within a subgraph feature space.

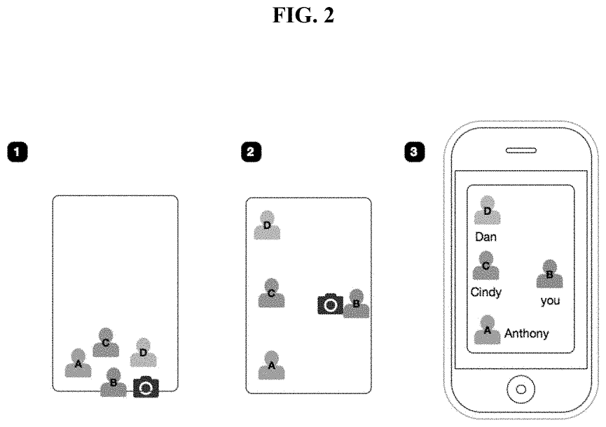

Referring to FIGS. 1 and 2, in step 101, the business card(s) of an attendee(s) met at or prior to the beginning of a meeting (or subsequently thereafter) are obtained and scanned. For example, the invention can use optical character recognition (OCR) from a wearable-device (e.g., glasses, camera, etc.) or an Internet-Of-Things (IoT) device and recognize the different bits of information and store them in a person database of some sort using existing technologies. A camera in the meeting room can also act as a scanner to scan the business card information.

In step 102, as the business cards are being exchanged (and/or possibly scanned), a camera takes a picture (e.g., captures an image) of the attendee with whom the host has just exchanged cards. The camera may be on the host's mobile device, worn by the host (e.g., camera glasses, etc.), in the vicinity of the exchange (e.g., on the wall, attached to a drone, in the overhead lighting, etc.). The business card and an image of the attendee who handed the host the business card are linked together (e.g., a data file is created that matches the business card with an image of the attendee that exchanged the business card) such that step 103 can identify a seating location of the attendee.

In step 103, once the attendee is seated at a seating location in the meeting room, the camera surveys the meeting room (e.g. via a specially outfitted outward-pointing pan-tilt-zoom camera on the outside of a user's laptop, which may take a panoramic shot, etc.), noting where each attendee is sitting and then matching the attendee identified from the facial recognition and business card matching with those who are seated. In other words, an association is made (e.g., via a data file, or the like) of the seating location of the attendee, the business card of the attendee, and the image of the attendee.

In step 104, and as exemplarily shown in FIG. 2, a map is created that depicts the seating arrangement, the attendees, and the business cards of the attendees. The map may depict more details about the attendees that are derived from the OCR scan of the business cards (e.g., company name, position, experience, contact information, etc.). Even more details about the attendees may be shown from the business card scanning or through additional automation (e.g., by looking up the attendee profile on a professional service website (e.g., LinkedIn™) scanning the web for information about them, etc.). The information may further include pronunciation of an attendee's name. That is, the map may also offer to help pronounce the name of each attendee, (e.g., if the host has headphones or an earpiece connected device).

In one embodiment, audio of the meeting may be recorded and associated with the voice of each attendee such that the map may include a feature in which an attendee may be selected and the notes about contributions to the meeting are listed with their name (e.g., what each attendee spoke about during the meeting is associated with their name).

In step 105, each of steps 101-104 is repeated for each attendee in the meeting such that the entire location map is created for all attendees of the meeting (e.g., as shown in FIG. 2 depicting a location of each attendee of the meeting).

In one embodiment, a feedback loop may be provided for a host to correct labels in the map. For example, a host may correct mistakes made by the map creation, or add additional information by typing in details (e.g. if an attendee is not recognized by the system). The additional information may be fed through a machine-learning algorithm to learn details that the host desires from the business cards and the method 100 may learn how to acquire the information or derive the information from the business cards.

In another embodiment, if there are multiple people in the meeting gathering business cards, and one of the people has gathered one handful of business cards and the another person has gathered a different handful of business cards, a sharing request may be sent between the people so that the business card information of the two or more parties may be shared. For example, a popup can appear in an application for the invention asking if the user wants to opt into business card sharing with their peers. Whether people are in the same meeting can be inferred since there will be overlaps in the collected cards (i.e., no GPS or other location tracking is required to make this determination).

In one embodiment, an initial check with an attendee database is performed prior to creating the map. In this manner, attendees with their information already scanned may be processed, not requiring the awkwardness of requiring a reintroduction and re-exchange of business cards.

In another exemplary embodiment, if a user has a private viewing device such as a wearable camera, heads-up display, etc., the method 100 may determine who the user is looking at and add an overlay of the host's name or business card details as a reminder (e.g., add the overlay in the near-field on the display screen). Also, in one embodiment, if a user were to get up to leave or move into a new seat, the visualization will be adjusted accordingly.

Thereby, the method 100 may improve a user's ability to remember the name, face, and position of an attendee based on the generated map.

For example, in one embodiment, Bob (e.g., the “user”) meets new clients at a client meeting. Everyone (e.g., Bob and the other attendees) exchanges business cards before heading to their parts of the table. The business cards are collected and associated to each attendee through facial recognition using Bob's wearable camera. When everyone is seated, Bob's camera again recognizes where each person is around the table. A dynamic mobile application may be presented on Bob's device (e.g., phone, lap top, etc.) that shows the business card information about each attendee based on image recognition with a map showing where each is seated. Bob might be bad with names and forgotten already that Cindy was across from him. Using the proposed method 100, Bob may quickly look at the device and see what Cindy's name is, the company she works with, her experience, and other potentially relevant information.

Thus, the method 100 provides a method for storing scanned business card information, capturing a photo of a person who the user has exchanged business cards with, automatically associating that photo with the information on the business card, and then matching the photo (and thereby the associated business card information) with the location of the attendee in a meeting seating arrangement as captured in a panoramic photo of all meeting attendees.

The method may additionally include an application that displays the panoramic photo of the attendees of the meeting and displays in some proximal fashion (e.g., below each person image, biographical information about the person as gleaned from the business card and/or from auxiliary information obtained about the person from a stored database or from the Internet).

Moreover, the method may include, additionally, a modified photo if meeting attendees are found to have moved or left the meeting, either by taking a new panoramic shot or by stitching together attendee images. If a new attendee enters the room, then the new attendee's image is added and a match is attempted against the user's repository of known attendees. The repository may include a company or other organizational directory or directories.

It is noted that the embodiments described herein reference the ‘host’ or ‘user’ of the meeting. However, multiple ‘hosts’ may attend a meeting and the ‘host’ does not need to be the actual ‘host’ (e.g., organizer) of the meeting. Instead, the method can be provided for any user, individual, attendee, etc. at the meeting.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (Paas): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, hut are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring now to FIG. 3, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer systems readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing circuit, other peripherals, such as display 24, etc., and one or more components that facilitate interaction with computer system/server 12. Such communication can occur via Input/Output (I/O) interface 22, and/or any circuits (e.g., network card, modem, etc.) that enable computer system/server 12 to communicate with one or more other computing circuits. For example, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

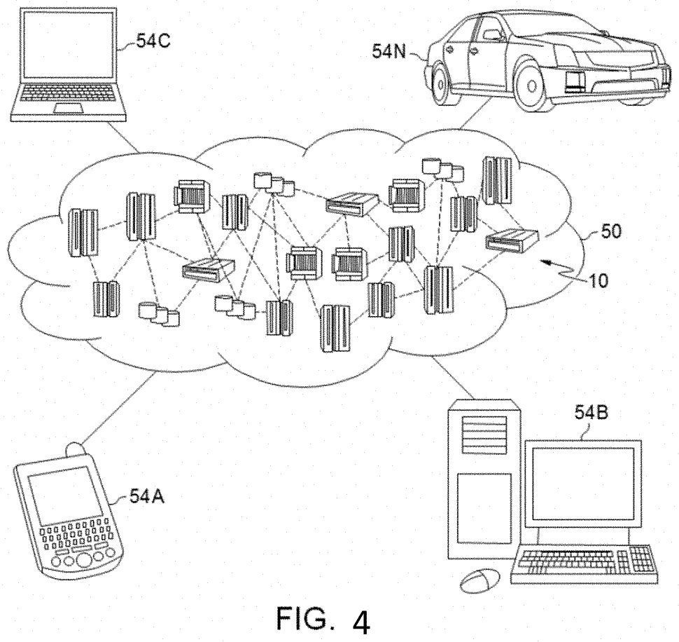

Referring now to FIG. 4, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 4 are intended to be illustrative only and that computing nodes 10 and cloud computing environment 50 can communicate with any type of computerized circuit over any type of network and/or network addressable connection (e.g., using a web browser).

Referring now to FIG. 5, an exemplary set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and business card information storing method 100 in accordance with the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented business card information storing method, the method comprising:
scanning a business card of an attendee of a meeting;
capturing an image of the attendee met at the meeting and associating the image with the scanned business card of the attendee;
surveying for a seat location of the attendee by matching the image of the person seated at a given location with the captured image of the attendee; and
associating the seat location of the attendee, the image of the attendee, and the business card of the attendee together.

2. The computer-implemented business card information storing method of claim 1, further comprising creating a map that depicts a pictorial representation of the seating location of the attendee, in conjunction with the image of the attendee and the business card of the attendee.

3. The computer-implemented business card information storing method of claim 2, further comprising incorporating the repeating the scanning, the capturing, the surveying, and the associating for a plurality of attendees at the meeting until the map associates a seating location of each of the plurality of attendees and their associated business cards.

4. The computer-implemented business card information storing method of claim 1, wherein the associating further includes a compilation of notes from an audio recording of a plurality of the attendees.

5. The computer-implemented business card information storing method of claim 1, wherein the associating checks a database of known associates, which contains images, names, and potentially business cards or other business information, and matches individuals encountered prior to or during the meeting and prior to the associating of the seating location of the attendee, the image of the attendee, and the business card of the attendee together.

6. The computer-implemented business card information storing method of claim 2, wherein the map is displayed on a heads-up display such that the attendee information is provided on the heads-up display for a user to reference when the host is looking at the attendee.

7. The computer-implemented method of claim 1, wherein the face recognition and/or the business card and retrieval of associated information is performed within a cloud-computing environment.

8. A computer program product for business card information storing, the computer program product comprising a computer-readable storage medium having program instructions embodied therewith, the program instructions executable by a computer to cause the computer to perform:
scanning a business card of an attendee of a meeting;
capturing an image of the attendee met at the meeting and associating the age with the scanned business card of the attendee;
surveying for a seat location of the attendee by matching the image of the person seated at a given location with the captured image of the attendee; and
associating the seat location of the attendee, the image of the attendee, and the business card of the attendee together.

9. The computer program product of claim 8, further comprising creating a map that depicts a pictorial representation of the seat location of the attendee associated with the image of the attendee and the business card of the attendee.

10. The computer program product of claim 9, further comprising repeating the scanning, the capturing, the surveying, the associating, and the creating for each attendee of a plurality of attendees at the meeting until the map associates each attendee with the seat location of each attendee and the business card of each attendee.

11. The computer program product of claim 8, wherein the associating further includes a compilation of notes from an audio recording of the attendee.

12. The computer program product of claim 8, wherein the associating checks a database for a prior attendee that matches the attendee prior to compiling the seat location of the attendee, the image of the attendee, and the business card of the attendee together.

13. The computer program product of claim 9, wherein the map is displayed on a heads-up display such that the attendee information is provided on the heads-up display for a user to reference when the host is looking at the attendee.

14. A business card information storing system, the system comprising:
a processor; and
a memory, the memory storing instructions to cause the processor to perform:
scanning a business card of an attendees of a meeting;
capturing an image of the attendee met at the meeting and associating the image with the scanned business card of the attendee;
surveying for a seat location of the attendee by matching the image of the person seated at a given location with the captured image of the attendee; and
associating the seat location of the attendee, the image of the attendee, and the business card of the attendee together.

15. The system of claim 14, further comprising creating a map that depicts a pictorial representation of the seat location of the attendee associated with the image of the attendee and the business card of the attendee.

16. The system of claim 15, further comprising repeating the scanning, the capturing, the surveying, the associating, and the creating for each attendee of a plurality of attendees at the meeting until the map associates each attendee with the seat location of each attendee and the business card of each attendee.

17. The system of claim 14, wherein the associating further includes a compilation of notes from an audio recording of the attendee.

18. The system of claim 14, wherein the associating checks a database for a prior attendee that matches the attendee prior to compiling the seat location of the attendee, the image of the attendee, and the business card of the attendee together.

19. The system of claim 15, wherein the map is displayed on a heads-up display such that the attendee information is provided on the heads-up display for a user to reference when the host is looking at the attendee.

20. The system of claim 14, wherein the face recognition and/or the business card and retrieval of associated information is performed within a cloud-computing environment.
